(19) United States
(12) Patent Application Publication
(10) Pub. No.: US 2026/0004157 A1
(43) Pub. Date: Jan. 1, 2026

(54) KNOWLEDGE GRAPH GENERATION SYSTEM

(71) Applicant: SAP SE, Walldorf (DE)

(72) Inventors: Sandra BRACHOLDT, Dielheim (DE); Jan Portisch, Bruchsal (DE)

(21) Appl. No.: 18/754,340

(22) Filed: Jun. 26, 2024

(51) Int. Cl. G06N 5/022

(52) U.S. Cl. CPC G06N 5/022

(57) ABSTRACT

System, method, and various embodiments for a knowledge graph generation system are described herein. An embodiment operates by receiving a command to generate a knowledge graph, and identifying a large language model (LLM) configured to parse documents in accordance with a prompt. A prompt for the LLM is generated, and a table, as requested via the prompt, is returned. The knowledge graph is generated based on the table, the knowledge graph including data extracted from the one or more documents by the large language model organized in accordance with the knowledge graph. The generated knowledge graph is returned.

### BACKGROUND

As part of their operations, companies (and other organizations) often collect large amounts of data which is stored in a wide variety of both organized and unorganized ways. Finding ways to organize and manage this data has become a critical part of how companies operate. Most companies store their data in a database. However, while database storage may be cost effective, if the company wants to add additional context to the data, then database storage becomes inefficient and ineffective.

### BRIEF DESCRIPTION OF THE DRAWINGS

The accompanying drawings are incorporated herein and form a part of the specification.

FIG. 1 is a block diagram illustrating example functionality for a knowledge graph generation system (KGS), according to some embodiments.

FIGS. 2A-2F are diagrams related to example operations of the KGS 102 as described herein, according to some embodiments.

FIG. 3 is a flowchart illustrating example operations for providing a knowledge graph generation system (KGS), according to some embodiments.

FIG. 4 is example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for providing a knowledge graph generation system.

As part of their operations, companies (and other organizations) often collect large amounts of data which is stored in a wide variety of both organized and unorganized ways. Finding ways to organize and manage this data has become a critical part of how companies operate. Most companies store their data in a database. However, while database storage may be cost effective, if the company wants to add additional context to the data, then database storage becomes inefficient and ineffective.

One additional or alternative approach to storing data in a database is to store the data in a knowledge graph. A knowledge graph allows for the storage and retrieval of additional contextual information that provides a greater understanding of the relationships between different pieces of data. For example, rather than storing Paris in one column and France in another column (as may be done in a database) without any relationship information, a knowledge graph may store ‘Paris cityIn France’ as a single record. This additional relationship information makes processing and understanding the data faster and applicable for more uses than if the data was stored in a traditional database.

A knowledge graph is a structured way to represent data. As illustrated in the example above, a knowledge graph record may connect two pieces of data with a relationship between the data. However, one of the drawbacks of using or converting data to be stored in a knowledge graph is the time, resources, expertise, often required to generate and maintain a knowledge graph. Generating knowledge graphs has been a largely manual process. For at least these reasons, despite their utility, knowledge graphs are often undesirable or unusable for larger sets of data.

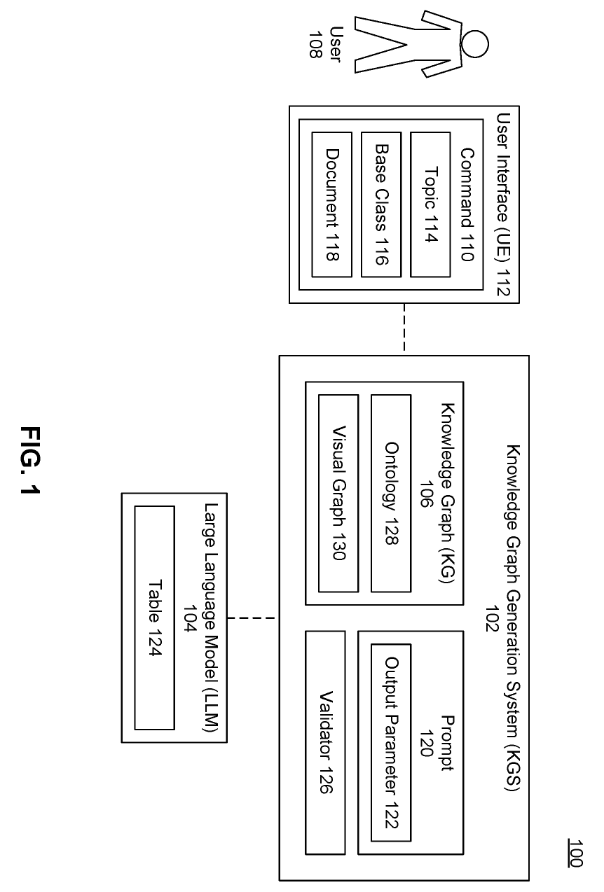

FIG. 1 is a block diagram 100 illustrating example functionality for a knowledge graph generation system (KGS) 102, according to some embodiments. KGS 102 may leverage the processing capabilities of a large language model (LLM) 104 to efficiently and automatically generate a knowledge graph (KG) 106.

In some embodiments, a user 108 may submit a command 110 via a user interface (UI) 112. The command 110 may include a request or instruction to generate a KG 106. In some embodiments, this command 110 may be generated a result of interactions by user 108 with UI 112.

The command 110 may include additional specifics or parameters describing or defining the KG 106 to be generated. For example, command 110 may include a topic 114, a base class 116, and a document 118.

Document 118 may include the identifier of one or more documents to be parsed for generating the KG 106. Document 118 may include a uniform resource location (URL), uniform resource indicator (URI), and/or the attachment of one or more files in any variety or combination of file formats (e.g., .doc, .pdf, .txt). For simplicity, only a single document 118 is illustrated, but it is understood that document 118 may include any number of documents. The terms document 118 and documents 118 may be used interchangeably.

Topic 114 may include a description of the type of information the user 108 wants the KG 106 to cover from the document 118. Topic 114 may include a conversational entry by the user, which may be spoken or typed – not aligned with any particular computing coding format. For example, document 118 may include a plurality of documents about cars. And topic 114 may include the “technology and features of cars”. Other topics 114 may include the “different types of wheels on cars” or “history of car manufacturers” or “I want a knowledge graph about the computer processing systems in cars”.

Base class 116 may include a class or object entered by the user 108. In some embodiments, base class 116 may include starting point or focal point for the KG 106. In some embodiments, base class 116 may include any object related to the topic 114 for which the user wants to build a KG 106. In continuing the example above, base class 116 may include for example, “car”, “tire”, “equipment”, or “battery”.

In some embodiments, command 110 may include additional other parameters or information not specifically illustrated in the example of FIG. 1. For example, command 110 may include a list of object properties, a number of details, and/or a depth parameter.

The list of object properties parameter may include a list of predicates that the KGS 102 can use to generating the records of the KG 106. A predicate may be the relationship between the subject and object in a triple. For example, in the triple: Paris cityIn France, cityIn is the predicate defining the relationship of the subject ‘Paris’ and the object ‘France’.

In some embodiments, the list of object properties may be restrictive, such that KG 106 cannot use any predicates which are not explicitly enumerated in the list. This may allow the user 108 further control and limit the generation of the KG 106 to whatever information or relationships / information that are most relevant to the user 108, without requiring the user 108 to manual parse or construct the KG 106 themselves. In some embodiments, KGS 102 may include a default list of predicates, visible the user 108 via user interface 112. As part of command 110, the user 108 may able to modify the list of predicates (edit, remove, or add) and use that list in the generation of KG 106.

The number of details parameter can be an indicator of how many classes are to be generated in addition to, or from the base class 116. For example, if the number of details parameter is set to 10, the KGS 102 may generate 9 additional classes in addition to base class 116 when generating KG 106. The user 108 may limit or expand this number to whatever the user 108 chooses via UI 112.

The depth parameter may indicate how many recursive levels KGS 102 is to generate for KG 106. For example, depth may be default of 1, which means KGS 102 may generate a simple knowledge graph with a single pass. But if depth is set to 2, then for each class generated during the first pass, KGS 102 may generate a sub-knowledge graph or sub-classes with the same properties or parameters indicated for the first pass, except that each generated class may serve as the base class 116 at the second recursive depth (e.g., while the topic 114 and documents 118 remain the same).

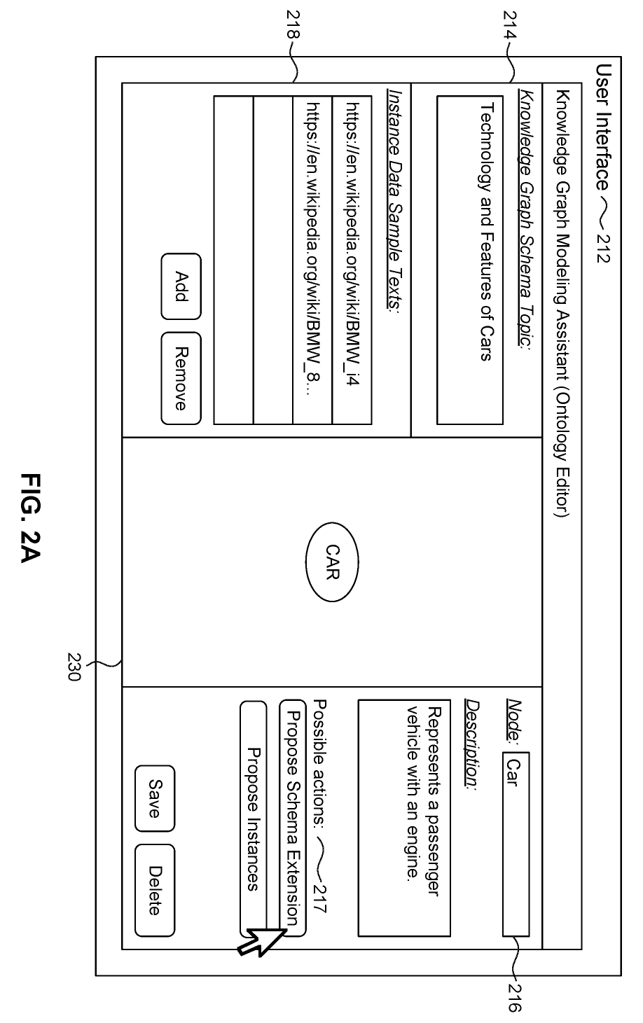

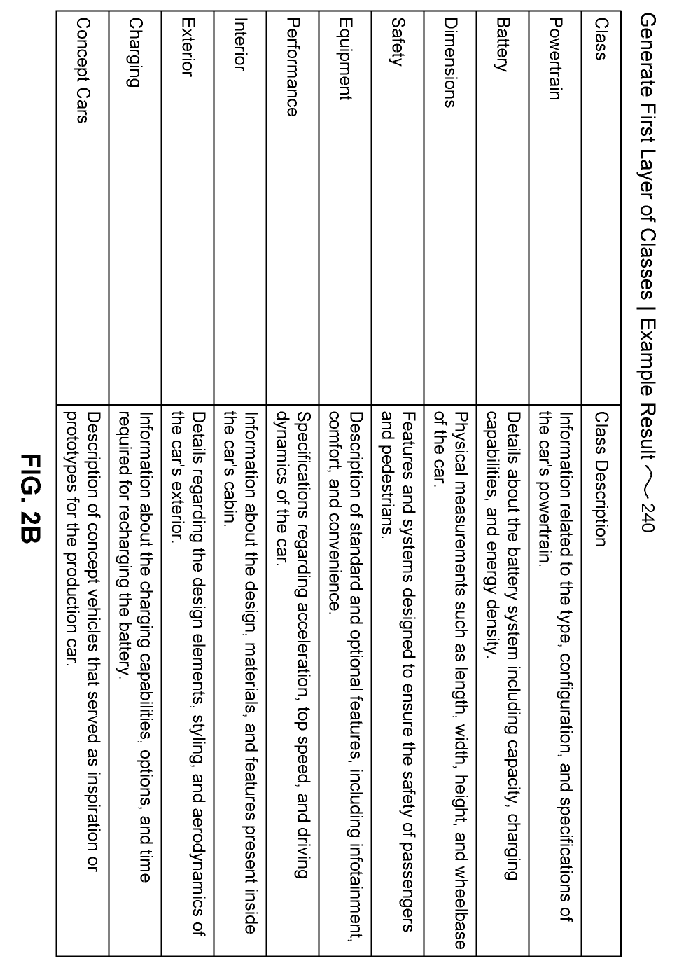

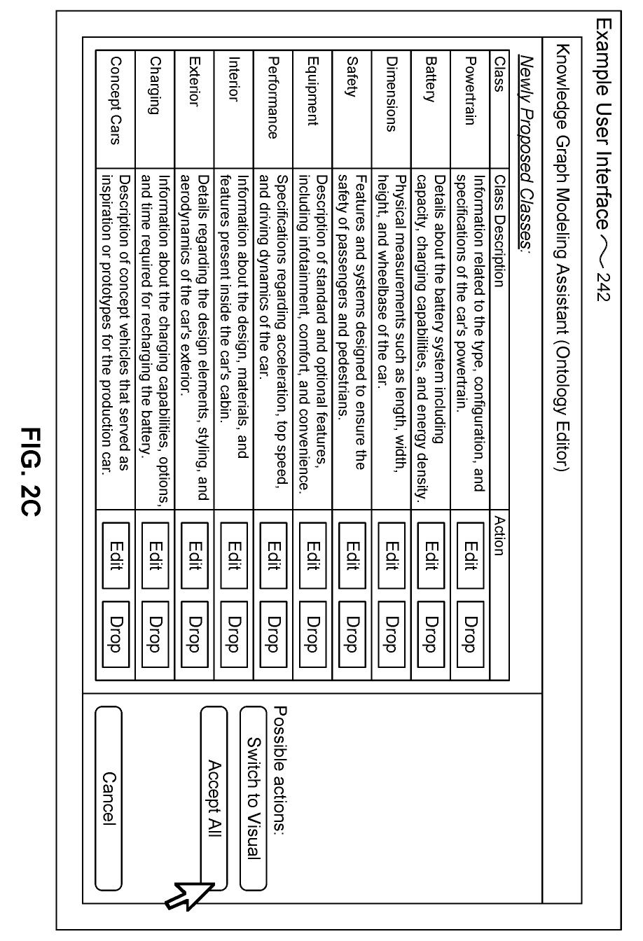

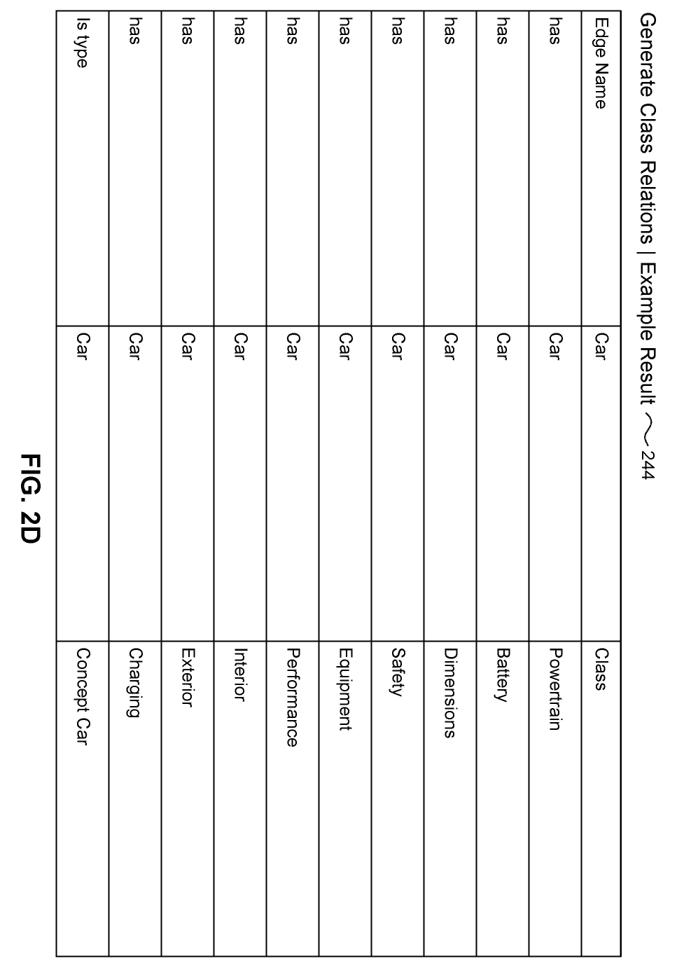

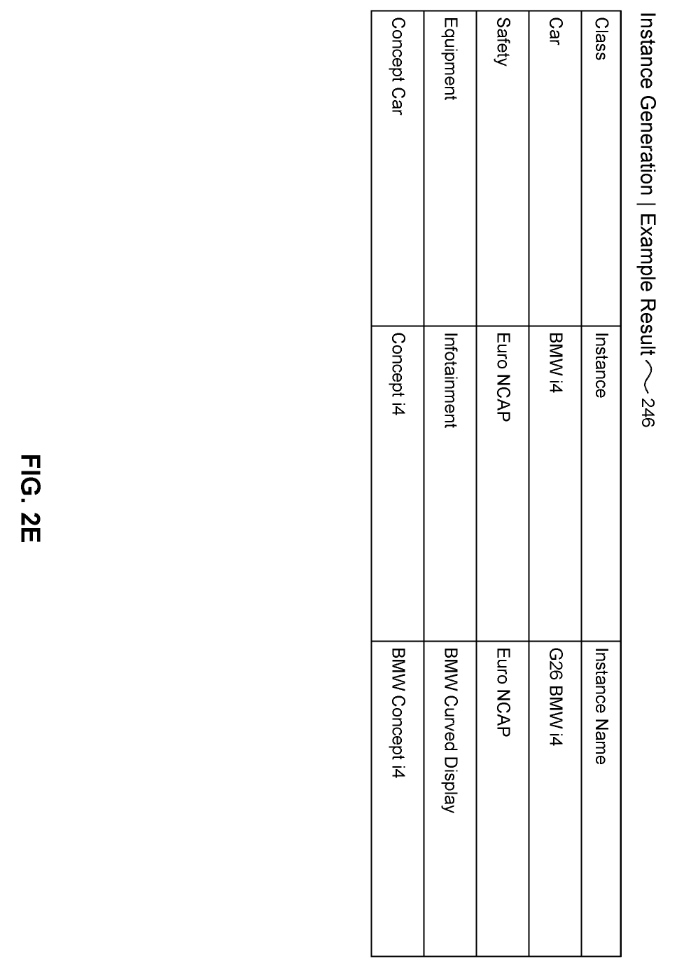

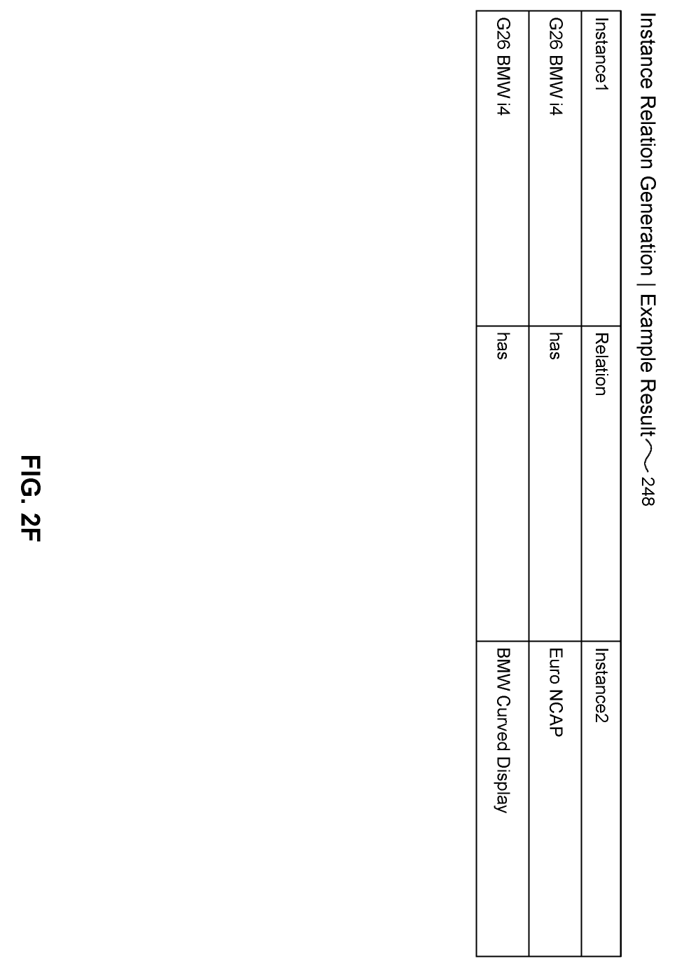

FIGS. 2A-2F are diagrams related to example operations of the KGS 102 as described herein, according to some embodiments. FIG. 2A illustrates an example user interface 212 (corresponding to UI 112) where a user 108 could enter the information or parameters of command 110. Topic box 214 may receive topic 114 and document box 218 may receive documents 118 from a user 108. Class box 216 may receive base class 116 information and any description the user 108 provides for the base class 116, which may help generate more accurate KG 106. In some embodiments, user interface 212 may also include actions area 217 where the user 108 may modify or request changes to the generated KG 106, which may be displayed in display box 230.

Returning to FIG. 1, upon receiving command 110, KGS 102 may generate a prompt 120. Prompt 120 may include one or more lines of text organized across one or more documents that is particularly formatted to by understandable by an LLM 104. LLM 104 may include an artificial intelligence, machine learning, or deep learning model that is configured to execute data processing commands from plain-text (e.g., not requiring computer language or coded input). LLM 104 may include any computing system that is configured to perform processing tasks based on text-based or plain language inputs. LLM 104 may be configured to create original content from one or more documents 118 in accordance with prompt 120. In some embodiments, LLM 104 may include a generative pre-training transformer (GPT).

In some embodiments, different LLMs 104 may require different prompts 120, or the format of the prompt 120 may impact the quality or type of results from the LLM 104. In some embodiments, KGS 102 may generate and format prompt 120 in accordance with whichever LLM(s) 104 are being used to perform the processing described herein, while using the same input command 110.

In some embodiments, KGS 102 may generate prompt 120 to include different information or parameters that may be helpful in instructing LLM 104 what to create or generate. For example, prompt 120 may include various parameters, such as text, context, task, and output. The text parameter may correspond the document(s) 118 of the command, and indicate the primary or exclusive source(s) of information LLM 104 is to rely upon when generating an output (e.g., table 124). The context parameter may correspond to the topic 114. The task parameter may include an indication to LLM 104 of how many classes to generate and what is the base class 116.

The output parameter 122 may specify what type of document, file, or output the LLM 104 is to generate. In some embodiments, output parameter 122 may specify that LLM 104 is to generate a table 124.

As will be described herein, there are multiple different types of prompts 120 that may be generated by KGS 102 as part of generating KG 106. For simplicity, a single prompt 120 is illustrated, however, as described below, the processes of KGS 102 may include generating multiple different types of prompts and receiving back various outputs (e.g., tables 124) from LLM 104. In some embodiments, KGS 102 may generate differnet types of prompts 120 including a classes prompt, knowledge graph schema prompt, instance generation prompt, and relation prompt. In some embodiments, each output or table 124 may be validated (by validator 126) prior to KGS 102 using the output or table 124 to generate a subsequent prompt 120 or in generating KG 106. As described in greater detail below, the output generated by LLM 104 in response to a first prompt 120, may be used as input or document 118, for a second or subsequent prompt 120.

In some embodiments, the output for the classes prompt may be used by KGS 102 to generate the knowledge graph schema prompt, and the output from the knowledge graph schema prompt may be used by KGS 102 to generate the instance generation prompt, and the output from the instance generation prompt may be used by KGS 102 to generate the relation prompt. In some embodiments, this sequential prompt generation may be performed automatically by KGS 102 without any user actions or intervention, except in the case of error or failure.

In some embodiments, KGS 102 may generate a classes prompt 120. In the classes prompt 120, the documents 118 may be provided as input or texts, and LLM 104 may be provided with a context. An example context for the classes prompt may include:

“These texts are used as a basis for a knowledge graph schema creation (ontology). The topic of the knowledge graph schema is “<kg_topic>” The variable kg_topic may correspond to topic 114.

The task for the classes prompt may be: “Based on these texts find a maximum of <number_of_details> general classes of information that describe the already existing class <base_class>.” The number_of_details may correspond to the number of details parameter described above (which may be a default or user specified number), and base_class may correspond to base class 116.

The output parameter 122 may indicate the column names for the table. For example, output parameter 122 may specify to create a table with two columns: class and class description are returned. As an example, the output parameter 122 for the classes prompt may be:

“Print a table with the following header: “Class”, “Class Description”. Return the table only. Please ensure that the proposed classes and descriptions are generic even though the provided texts may describe individual instances.”

KGS 102 may provide the prompt 120, including the output parameter 122, to LLM 104. LLM 104 may access the documents 118 and generate and return the requested table 124 (or whatever other output is specified by output parameter 122). In other embodiments, the output generated by LLM 104 may be specified in other forms, including but not limited to a table. LLM 104 may return the output (e.g., table 124) to KGS 102.

FIG. 2B illustrates an example table 240 that may be generated by LLM 104 as a result of processing the classes prompt described above. FIG. 2C illustrates how the table 240 may optionally be provided to the user 108 via user interface 242. The user 108 may have the option of modifying the output from LLM 104 before processing continues. In some embodiments, the user 108 may elect not to perform any modifications and KGS 102 may process the command 110 all the way through to KG 106 generation without any additional user input. In other embodiments, the option for the user to modify the output may be disabled.

In some embodiments, a validator 126 may validate the output received from LLM 104. In some cases, LLM 104 may not be able to properly generate table 124 in accordance with prompt 120 for any number of reasons. Validator 126 may check table 124 (or whatever other output is generated by LLM 104) to ensure that the output parameter 122 has been satisfied. For example, LLM 104 may misunderstand the output parameter 122 and create output different from than that specified by output parameter 122, or may generate an error message. Validator 126 may validate that the output from LLM 104 corresponds to output parameter 122.

In some embodiments, validator 126 may receive the output parameter 122 as well as the table output 124 from LLM 104 and perform a comparison and generate a similarity or comparison score. Then, for example, if the comparison score exceeds a threshold, KGS 102 may continue processing the table 124. However, if the comparison score is below a threshold, then KGS 102 may re-generate the prompt 120 using a different format for LLM 104, re-submit the prompt 120 to the same LLM 104, regenerate a new prompt 120 for a different LLM 104, and/or provide a notification to the user 108 indicating the error.

In some embodiments, KGS 102 may generate multiple different prompts 120 for different purposes, part of generate a KG 106 in accordance with command 110. For example, KGS 102 may generate a prompt to generate a knowledge graph schema. This knowledge graph schema prompt may include the table 124 (e.g. which may have been validated by validator 126), a context indicating:

“Table is used as a basis for knowledge graph schema creation. The topic of the knowledge graph schema is <kg_topic>. The base class is <base_class>.” The kg_topic variable may correspond to topic 114, while the base_class variable may corresponding to base class 116.

The prompt may further specify a task that indicates to “Create the knowledge graph schema, and an output parameter 122 specifying the following:

“Print a table with the following header: “Edge Name”, <base_class>, “Class” containing the edges of the knowledge graph schema. Class is the class of the table. “Edge Name” is a meaningful relationship between “<base_class>" and "Class". The table shall include all classes from table at least once.”

FIG. 2D illustrates an example table 244 that may be generated by LLM 104 as a result of processing the generate a knowledge graph schema prompt described above.

Another prompt 120 which may be generated by KGS 102, as part of generating KG 106, includes an instance generation prompt. This instance generation prompt may include a context indicating:

“Table is used as a basis for knowledge graph schema creation. The topic of the knowledge graph schema is <kg_topic>. The kg_topic variable may correspond to topic 114.

The prompt may further provide a list of classes and specify a task that indicates to “Based on these texts find instances for the classes,” while providing the documents 118. The output parameter 122 specifying the following:

“Print a table with the following header: “Class”, “Instance”, “Instance Name”. Return the table only. Ensure that the proposed classes are from the set of existing classes.”

FIG. 2E illustrates an example table 246 that may be generated by LLM 104 as a result of processing the instance generation prompt described above.

Another prompt 120 which may be generated by KGS 102, as part of generating KG 106, includes a relation prompt. This relation prompt may include the documents 118 and, a context indicating:

“Table is used as a basis for knowledge graph schema creation. The topic of the knowledge graph schema is <kg_topic>.” The kg_topic variable may correspond to topic 114.

The relation prompt may further provide the output from the instance generation prompt (which may have been validated by validator 126) and specify a task that indicates to “Relate the instances to each other where appropriate”. The output parameter 122 specifying the following:

“List the result directly as table with the header: Instance 1, relation, Instance 2. Print only the table.”

FIG. 2F illustrates an example table 248 that may be generated by LLM 104 as a result of processing the relation prompt described above.

Upon generating and submission of the various prompts 120 and results (e.g., tables 124) from LLM 104 (including validation by validator 126), KGS 102 may generate knowledge graph (KG) 106 from the output(s) received from the LLM 104.

In some embodiments, KGS 102 may generate an ontology 128 and a visual graph 130 as part of KG 106. Ontology 128 may include a schema, dictionary, or common vocabulary for the knowledge graph 106. In some embodiments, ontology 128 may include a list of triples, which may or may not be sorted or organized, such as Tbox that includes terminology.

Visual graph 130 may include a visual depiction of the triples of the ontology 128 in way that may be displayed via UI 112 for user approval and/or modification which may comprise information corresponding to an Abox with assertions that provide greater context beyond simple storage. In some embodiments, the visual graph 130 may include a visual depiction of classes which are connected to each other by the way of lines or edges. For example, a “car” class may be connected to an “equipment” class which may be connected to a “tires” class. The “car” class may also be connected to a “powertrain” class which is not connected to any other class. In some embodiments, the KG 106 may be provided back to LLM 104 for training or to a different LLM or artificial intelligence model for training.

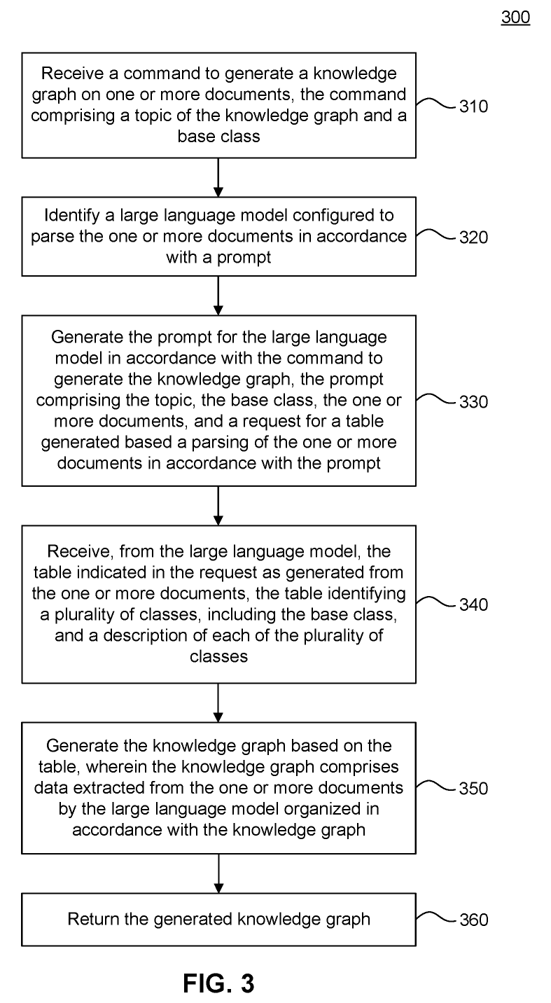

FIG. 3 is a flowchart 300 illustrating example operations for providing a knowledge graph generation system (KGS), according to some embodiments. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art. Method 300 shall be described with reference to FIG. 1.

In 310, a command to generate a knowledge graph on one or more documents is received, the command comprising a topic of the knowledge graph and a base class. For example, KGS 102 may receive command 110 from a user 108, which may be submitted via user interface 112. Command 110 may include base class 116 and an instruction to generate a knowledge graph 106.

In 320, a large language model configured to parse the one or more documents in accordance with a prompt is identified. For example, KGS 102 may identify which LLM 104 to use. In some embodiments, there may be only a single available LLM 104. In some embodiments, the user 108 may specify which LLM 104 to use (e.g., by selecting from a list of available LLM 104 provided via UI 112).

In 330, the prompt for the large language model is generated in accordance with the command to generate the knowledge graph, the prompt comprising the topic, the base class, the one or more documents, and a request for a table generated based a parsing of the one or more documents in accordance with the prompt. For example, KGS 102 may generate a prompt 120 formatted as input for LLM 104. The prompt 120 may include output parameter 122 which may include a request for a table 124 generated based a parsing of the one or more documents 118.

In 340, the table indicated in the request as generated from the one or more documents is received from the large language model,, the table identifying a plurality of classes, including the base class, and a description of each of the plurality of classes. For example, KGS 102 may receive the table 124 (also illustrated in FIGS. 2B and 2C) from LLM 104. The table 124 may include a class column, a description column, and in some embodiments, the user 108 may be provided the opportunity modify the generated table 124.

In 350, the knowledge graph is generated based on the table, wherein the knowledge graph comprises data extracted from the one or more documents by the large language model organized in accordance with the knowledge graph. For example, KGS 102 may generate KG 106 based on the table 124. In some embodiments, KGS 102 may generate several more prompts 120 for LLM 104 and receive several more outputs (e.g., tables 124), all which may be used to contribute to the generation of KG 106. As described above these prompts may include a classes prompt, knowledge graph schema prompt, instance generation prompt, and relation prompt. In some embodiments, KGS 102 may populate the KG 106 with data (only) extracted from the indicated documents 118.

In 360, the generated knowledge graph is returned. For example, KGS 102 may return the KG 106. KG 106 may then be used for any purposes the user 108 desires. In some embodiments, KG 106 may be provided as input for LLM 104 or a different artificial intelligence (AI) system which is configured to ‘learn’ or be trained based on the KG 106 generated by KGS 102. In some embodiments, it may be easier or more effective to submit a KG 106 as training for an AI system, than if similar data was stored in a traditional database.

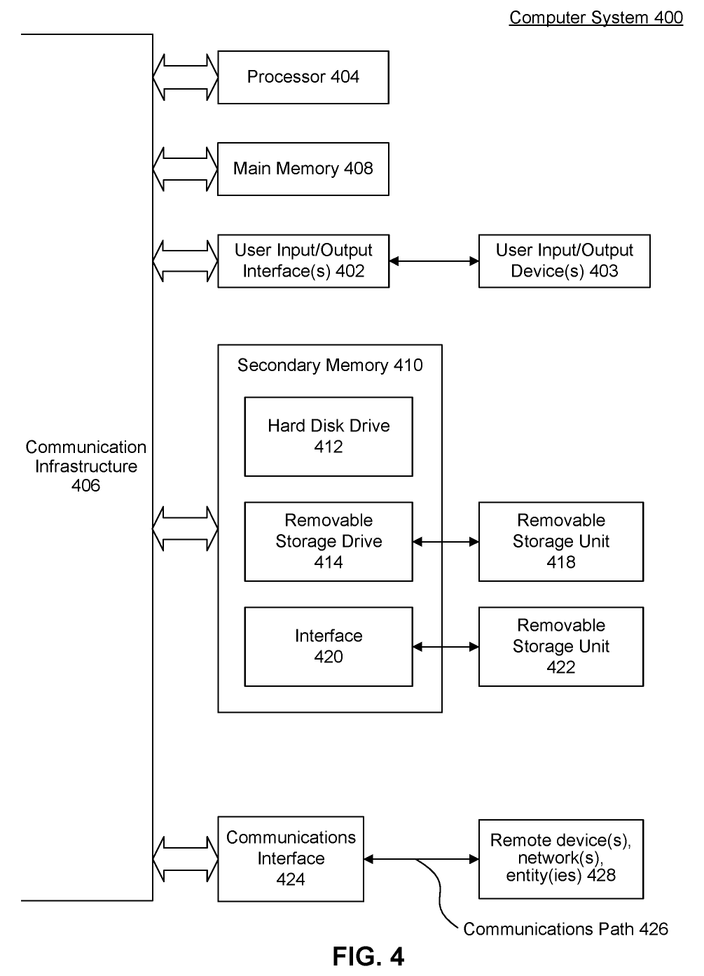

Various embodiments may be implemented, for example, using one or more well-known computer systems, such as computer system 400 shown in FIG. 4. One or more computer systems 400 may be used, for example, to implement any of the embodiments discussed herein, as well as combinations and sub-combinations thereof.

Computer system 400 may include one or more processors (also called central processing units, or CPUs), such as a processor 404. Processor 404 may be connected to a communication infrastructure or bus 406.

Computer system 400 may also include user input/output device(s) 403, such as monitors, keyboards, pointing devices, etc., which may communicate with communication infrastructure 406 through user input/output interface(s) 402.

One or more of processors 404 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 may also include a main or primary memory 408, such as random access memory (RAM). Main memory 408 may include one or more levels of cache. Main memory 408 may have stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 may include a computer usable or readable storage device having stored thereon computer software (control logic) and/or data. Removable storage unit 418 may be a floppy disk, magnetic tape, compact disk, DVD, optical storage disk, and/ any other computer data storage device. Removable storage drive 414 may read from and/or write to removable storage unit 418.

Secondary memory 410 may include other means, devices, components, instrumentalities or other approaches for allowing computer programs and/or other instructions and/or data to be accessed by computer system 400. Such means, devices, components, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 may enable computer system 400 to communicate and interact with any combination of external devices, external networks, external entities, etc. (individually and collectively referenced by reference number 428). For example, communication interface 424 may allow computer system 400 to communicate with external or remote devices 428 over communications path 426, which may be wired and/or wireless (or a combination thereof), and which may include any combination of LANs, WANs, the Internet, etc. Control logic and/or data may be transmitted to and from computer system 400 via communication path 426.

Computer system 400 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 4. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method, comprising:
receiving, from a user, a command to generate a knowledge graph on one or more documents, the command comprising a topic of the knowledge graph and a base class;
identifying a large language model configured to parse the one or more documents in accordance with a prompt;
generating the prompt for the large language model in accordance with the command to generate the knowledge graph, the prompt comprising the topic, the base class, the one or more documents, and a request for a table generated based on a parsing of the one or more documents in accordance with the prompt;
receiving, from the large language model, the table indicated in the request as generated from the one or more documents, the table identifying a plurality of classes, including the base class, and a description of each of the plurality of classes;
generating the knowledge graph based on the table, wherein the knowledge graph comprises data extracted from the one or more documents by the large language model organized in accordance with the knowledge graph; and
returning, to the user, the generated knowledge graph.

2. The computer-implemented method of claim 1, further comprising:
validating the table received from the large language model, wherein the validating comprises comparing the table received from the large language model to the request to ensure compliance of the table received from the large language model with the request; and
providing the validated table for display to the user via a user interface.

3. The computer-implemented method of claim 2, further comprising:
receiving, via the user interface, one or more modifications to the displayed table, wherein the one or more modifications are integrated into the knowledge graph.

4. The computer-implemented method of claim 3, wherein the one or more modifications comprise modifications to one or more of the plurality of classes.

5. The computer-implemented method of claim 1, wherein the topic provides a general description of the knowledge graph.

6. The computer-implemented method of claim 1, wherein the generating the knowledge graph comprises:
generating a set of triples from the knowledge graph, each triple comprising the data extracted from the one or more documents by the large language model.

7. The computer-implemented method of claim 1, wherein the generating the knowledge graph comprises:
generating both an ontology for the knowledge graph and a visual depiction of the ontology.

8. The computer-implemented method of claim 7, further comprising:
receiving a subsequent request from the user to change one of the ontology or the visual depiction;
generating a subsequent prompt in accordance with the subsequent request;
receiving a subsequent table from the large language model in accordance with the subsequent prompt; and
generating a subsequent knowledge graph based on the subsequent table, wherein the subsequent knowledge graph replaces the knowledge graph generated based on the table.

9. The computer-implemented method of claim 1, wherein the generating the prompt comprises generating a plurality of prompts, wherein each of the plurality of prompts corresponds to receiving a unique output from the large language model.

10. A system comprising:
a memory; and
at least one processor coupled to the memory and configured to perform operations comprising:
receiving, from a user, a command to generate a knowledge graph on one or more documents, the command comprising a topic of the knowledge graph and a base class;
identifying a large language model configured to parse the one or more documents in accordance with a prompt;
generating the prompt for the large language model in accordance with the command to generate the knowledge graph, the prompt comprising the topic, the base class, the one or more documents, and a request for a table generated based on a parsing of the one or more documents in accordance with the prompt;
receiving, from the large language model, the table indicated in the request as generated from the one or more documents, the table identifying a plurality of classes, including the base class, and a description of each of the plurality of classes;
generating the knowledge graph based on the table, wherein the knowledge graph comprises data extracted from the one or more documents by the large language model organized in accordance with the knowledge graph; and
returning, to the user, the generated knowledge graph.

11. The system of claim 10, the operations further comprising:
validating the table received from the large language model, wherein the validating comprises comparing the table received from the large language model to the request to ensure compliance of the table received from the large language model with the request; and
providing the validated table for display to the user via a user interface.

12. The system of claim 11, the operations further comprising:
receiving, via the user interface, one or more modifications to the displayed table, wherein the one or more modifications are integrated into the knowledge graph.

13. The system of claim 12, wherein the one or more modifications comprise modifications to one or more of the plurality of classes.

14. The system of claim 10, wherein the topic provides a general description of the knowledge graph.

15. The system of claim 10, wherein the generating the knowledge graph comprises:
generating a set of triples from the knowledge graph, each triple comprising the data extracted from the one or more documents by the large language model.

16. The system of claim 10, wherein the generating the knowledge graph comprises:
generating both an ontology for the knowledge graph and a visual depiction of the ontology.

17. The system of claim 16, the operations further comprising:
receiving a subsequent request from the user to change one of the ontology or the visual depiction;
generating a subsequent prompt in accordance with the subsequent request;
receiving a subsequent table from the large language model in accordance with the subsequent prompt; and
generating a subsequent knowledge graph based on the subsequent table, wherein the subsequent knowledge graph replaces the knowledge graph generated based on the table.

18. The system of claim 10, wherein the generating the prompt comprises generating a plurality of prompts, wherein each of the plurality of prompts corresponds to receiving a unique output from the large language model.

19. A non-transitory computer-readable medium having instructions stored thereon that, when executed by at least one computing device, cause the at least one computing device to perform operations comprising:
receiving, from a user, a command to generate a knowledge graph on one or more documents, the command comprising a topic of the knowledge graph and a base class;
identifying a large language model configured to parse the one or more documents in accordance with a prompt;
generating the prompt for the large language model in accordance with the command to generate the knowledge graph, the prompt comprising the topic, the base class, the one or more documents, and a request for a table generated based on a parsing of the one or more documents in accordance with the prompt;
receiving, from the large language model, the table indicated in the request as generated from the one or more documents, the table identifying a plurality of classes, including the base class, and a description of each of the plurality of classes;
generating the knowledge graph based on the table, wherein the knowledge graph comprises data extracted from the one or more documents by the large language model organized in accordance with the knowledge graph; and
returning, to the user, the generated knowledge graph.

20. The non-transitory computer-readable medium of claim 19, wherein the generating the prompt comprises generating a plurality of prompts, wherein each of the plurality of prompts corresponds to receiving a unique output from the large language model.
